(19) United States
(12) Patent Application Publication
(10) Pub. No.: US 2025/0128838 A1
(43) Pub. Date: Apr. 24, 2025

(54) FILLING MACHINE AND METHOD FOR FILLING FOOD AND FOR ADAPTING THE PRESSURE IN A COMPRESSION REGION OF A PUMP

(71) Applicant: Albert Handtmann Maschinenfabrik GmbH & Co. KG, Biberach (DE)

(72) Inventors: Martin Staudenrausch, Biberach (DE); Marcel Nusser, Laupheim (DE)

(21) Appl. No.: 18/920,231

(22) Filed: Oct. 18, 2024

(30) Foreign Application Priority Data
Oct. 20, 2023 (EP) 23204854.6

(51) Int. Cl. B65B 1/30

(52) U.S. Cl. CPC B65B 1/30

(57) ABSTRACT

The disclosure relates to a filling machine for filling filling material, in particular food, with a pump that comprises an inlet region, a compression region and an outlet region, where the filling machine furthermore comprises a first pressure sensor for measuring a pressure in the compression region and an adjustment device for adjusting different pressures in the compression region. The disclosure also relates to a method for filling the filling material with a corresponding filling machine.

### CROSS REFERENCE TO RELATED APPLICATION

The present application claims priority to European Patent Application No. 23204854.6 filed on Oct. 20, 2023. The entire contents of the above-listed application are hereby incorporated by reference for all purposes.

### TECHNICAL FIELD

The disclosure relates to a filling machine and to a method for filling food and for adapting the pressure in a compression region of a pump.

### BACKGROUND

Filling machines are used to fill filling material, in particular food. As is evident, for example, from FIG. 1, food, such as sausage meat or a pasty substance for a vegetarian or vegan product, is filled into a funnel 101 and ejected through stuffing tube 102 via a Conveying Mechanism. When producing portioned food, such as sausages, the quality and consistency, on the one hand, and the portion accuracy, on the other hand, are of great significance. It is therefore important that a uniform flow of the filling material is created and that the filling material strand also has a density that is as uniform as possible so that individual portions can be produced having identical weight and identical quality and consistency.

### SUMMARY

In addition to the proper filling of, for example, the conveying chambers of a pump, it is also important to prevent pulsation of the filling material discharge, as described in EP0718497B1, EP0583721 B1 and also in EP2532244 A1. This pulsation is caused by a pressure difference between the outlet and the opening conveying chamber of the pump, i.e. a pressure difference between the compression region of a pump and an outlet region.

Different pressures can prevail at the outlet of the pump and are largely determined by the type of product (viscosity, chunkiness, cohesion, compressibility, etc.), the filling speed of the pump, process equipment connected to the pump, which results in a pressure loss. This can be, for example, pipes, deflections, filling flow dividers, etc. This process equipment cannot be detected by the filling machine so that the machine control device has no information in this regard and corresponding parameters that influence the pressure cannot be taken into account.

If the pressure in the compression region, for example, in the conveying chambers, is selected such that it corresponds to the pressure in the outlet region of the pump, then an ideal pressure equilibrium arises and pulsation can be effectively prevented. If there are pressure differences between the compression region and the outlet region of the pump, a sudden backflow (P_{compression}<Pₒᵤₜₗₑₜ) or forward flow (P_{compression}>Pₒᵤₜₗₑₜ) arises in the outlet region of the pump when the pressurized conveying chambers are opened to the outlet region.

Attempts have already been made to effectively minimize pulsation. A pump for delivering filling material, for example flowable, pasty or chunky food substances, for example, a rotary vane pump, comprises an inlet region into which the filling material enters the pump, for example, from the funnel shown in FIG. 1, a compression region in which the volume in the conveying chamber is reduced in the direction of rotation or direction of motion, respectively, and an outlet region The compression region is disposed between the inlet region and the outlet region. Attempts have already been made to limit the compression pressure in the compression region that acts upon a compressible or incompressible medium. For example, a spring-loaded pressure relief valve, as described in EP0718497 B1, is used with a compensating piston for this purpose. If the pressure rises above a certain value, the excess product can be discharged in the direction of the pump inlet via the pressure relief valve, for example, into a return channel that the compensating piston opens when actuated. This means that the pressure cannot increase further, or only increases slightly. Prior art also includes weight compensation with a storage cylinder without a return channel, as described, for example, in EP0583721 B1.

For example, the pressure relief valve and consequently the compression are adapted there once to the air content of a specific filling material. The opening pressure of the compensating piston of the pressure relief valve is therefore selected to suit the desired protection of the product, the leakage in the delivery mechanism, and the pressure at the pump outlet. The compression pressure in prior art is therefore set to a specific value, i.e. statically defined and is determined by using a spring with a specific spring constant/spring characteristic and the preload geometrically determined by the installation space. The device is configured such that when the opening pressure is exceeded, the excess filling material can be returned, for example, via a bypass channel, to the downstream conveying chamber in the inflow region.

As is evident from FIG. 1, the filling material is delivered in sausage meat trolleys and filled into funnel 101. It can happen that various batches differ, i.e. exhibit different compressibility, chunkiness, air content, etc.

The pressure set in the compression region for salami meat is, for example, unsuitable for white sausage meat or a pasty substance for a vegan product. But even with one and the same filling product, fluctuations in compressibility can occur depending on the batch, which leads, firstly, to quality problems and also to weight fluctuations.

The system set to a fixed opening pressure of the pressure relief valve cannot react to such changes.

The different compressibility beyond that leads, for example, to a pressure difference between the compression region and the outlet region which entails pulsation and therefore causes weight fluctuations in the strand of filling material and consequently to poor weight accuracy of the individual portions, e.g. sausages. According to the Prepackaged Packaging Ordinance (FPackV), the weight stated on a prepackaged product may only be undercut to a small extent so that the weight or mass of the portion is a certain amount, e.g. 1 g, above the stated weight, to be on the safe side, so that, for example, fluctuations in compressibility do not result in the stated weight being undercut. This leads to an enormous loss of filling material. When producing 200,000 portions with a total weight of 10 t per day, the loss is in the range of 200 kg, which represents an enormous economic loss.

In prior art, either a different pressure relief valve was installed for different filling materials or manual mechanical adjustment was performed, which required the machine to be at a standstill. This does not compensate for fluctuations during the process. In addition, exact adjustment or adaptation of the pressures in the compression region and the outlet region is not possible. Continuous, reliable operation in this respect is not possible.

Starting out from there, the present disclosure is based on the object of providing a filling machine as well as a corresponding method that enable improved continuous filling of filling materials with varying compressibility.

According to the disclosure, this object is satisfied.

The filling machine according to the disclosure for filling the filling material, in particular food, comprises a pump that comprises an inlet region, a compression region, and an outlet region. The compression region is arranged separated between the inlet region and the outlet region. The filling machine is configured in particular to fill pasty substances, in particular compressible media such as sausage meat, pasty substances for vegan products, etc., but also dough. In the compression region, the filling material supplied via the inlet region is transported and compressed by conveying elements in the direction towards the outlet region and pushed out of the pump via an outlet region, for example, into a stuffing tube for producing sausages.

According to the disclosure, the filling machine comprises a first pressure sensor for measuring a pressure in the compression region, e.g. in the at least one conveying chamber. The pressure in the compression region can thus be detected. The sensor is preferably arranged such that it measures a pressure that corresponds substantially to the pressure in the conveying chamber before the latter opens to the outlet region. The compression region can comprise a first region in which the volume of the filling material is compressed such that a corresponding pressure is established and a downstream region (e.g. downstream in the direction of rotation for vane pumps or in the transport direction for auger pumps) in which no further compression takes place but the pressure is substantially maintained. The pressure in the compression region can be set, for example, to be equal to or greater than the pressure in the outlet region. If the pressure in the compression region is set to be higher, as described, for example, a pressure drop due to leakage can be compensated for.

A pressure sensor, or pickup, or probe is therefore understood to be a device for detecting pressure, where the measured variable detected is converted into a corresponding electrical signal. The following devices can be used as pressure sensors, for example: piezo-resistive sensor, strain gauge-based pressure sensors, inductive or capacitive pressure sensors, etc.

The sensor can also be integrated, for example, into the adjustment device. The pressure or the pressure change can then be detected by way of a drive, in particular a linear actuator or spindle drive, respectively, by way of open-loop control evaluation of the drive current during the motion or the holding current when, for example, a piston is at a standstill. The drive current increases as the pressure increases. This means that a separate pressure sensor can be saved. The sensor can be calibrated accordingly in advance.

The present disclosure furthermore comprises an adjustment device for adjusting different pressures in the compression region, i.e. during production without machine idle time and without interrupting production.

The pressure in the compression region can then be measured continuously or at intervals and set to a specific pressure value continuously or at intervals during production, where this pressure value can be changed. In prior art in contrast, in which, for example, a pressure relief valve that is statically set to a predetermined pressure is used, no adaptation during production, in particular no continuous adaptation and no continuous and dynamic adjustment of different pressures during production, is possible.

According to the disclosure, it is possible to react quickly and in a simple manner to changing process conditions and fluctuations, such as a different air content in food and the associated different compressibility, by adapting the pressure in the compression region. The respective pressure in the compression region can be measured and set to a suitable value for different filling materials.

Defined conditions can be set in the compression region such that it is possible to react to changing pressures in the outlet region, for example, to prevent pulsation. The pressure sensor in the compression region and the adjustment device can therefore ensure greater portion accuracy, i.e. weight accuracy per portion, and ultimately more economical production. It can also be prevented that the filling material is mechanically stressed by excessive pressure in the compression region, since the pressure is adjustable, in particular for changing filling materials. In particular, the maximum possible pressure can now be set for different filling materials as a function of the air content and the type of product.

The pressure can be set dynamically by the adjustment device. Dynamic adjustment is understood to mean adjusting different pressures using a controllable adjustment device that carries out a corresponding motion.

According to a preferred embodiment, the filling machine comprises a second pressure sensor in the outlet region for measuring a pressure in the outlet region. If this pressure is known, then the pressure in the compression region can be adapted to the pressure in the outlet region using the adjustment device, for example, by an operator or in particular also by a respective control device which is configured such that it controls the pressure in the compression region in a closed-loop manner as a function of the pressure measured in the outlet region, where the pressure in the compression region is preferably the controlled variable and the pressure in the outlet region is the reference variable.

A respective control device has the advantage that, during production, the pressure in the compression region can be continuously and dynamically adjusted, for example, to the pressure in the outlet region such that no pulsation arises, even if fluctuations in the air content in the filling material arise or a change in the filling material occurs. The operator can therefore always assume that the pressure conditions are correct. Even if, for example, the delivery speed, i.e. the delivery rate per time of the pump, is changed, the correct pressure conditions automatically arise.

The pressure in the compression region is also preferably the controlled variable and the pressure in the outlet region is preferably the reference variable.

The control device is preferably configured such that the pressure in the compression region is controlled in a closed-loop manner as controlled variable X and the actual value is the pressure measured by the first and the target value is the pressure measured in the outlet region by the second pressure sensor and the actuator is the adjustment device.

According to a preferred embodiment, the adjustment device is configured as a pressure limiter and, if a target pressure in the compression region is exceeded, excess volume can be discharged from the compression region, in particular from a conveying chamber, for example, via a discharge line, for example, back to the inlet region or be delivered to a compensating cylinder which receives the excess volume and can optionally return it, for example, to a downstream conveying chamber (viewed in the direction of rotation). In this case, enough volume is diverted that the appropriate pressure, i.e. in particular the target pressure, can be established.

According to a preferred embodiment, the target pressure in the compression region is dynamically adaptable, i.e. is variable and therefore does not have to be constant. The target pressure can correspond, for example, to the opening pressure of an adjustment device, for example, a pressure relief valve that opens at a certain pressure. This opening pressure is therefore also variable, i.e., dynamically adjustable and can change during production, which was not possible in prior art.

The adjustment device is advantageously configured as a valve. This can be, for example, a valve that can be controlled by way of the control device and opens when the pressure measured in the compression region is too high and discharges a sufficient amount of volume until a correct pressure is established and then, for example, closes again. According to a particular embodiment, the valve is a pressure relief valve that can be integrated into the compression region in a simple manner and that opens when the target pressure is exceeded. The adjustment device can also comprise a compensating cylinder with a compensating piston, where excess volume is discharged into the compensating cylinder when the target value is exceeded, where, for example, a compensating piston is moved back in the compensating cylinder to an extent until a corresponding volume is discharged in order to set the corresponding target pressure.

The pressure sensor in the compression region is in communication with a conveying chamber of the pump, for example, a conveying chamber of a rotary vane pump or of the conveying chamber, i.e. the conveying auger of an auger pump or twin-auger pump in which the compressed filling material is disposed.

The adjustment device is preferably configured as a pressure relief valve and comprise, for example, a spring that is preloaded by a device for generating counter pressure, where the spring load dynamically adjustable by the device for generating counter pressure (44, 45, 46) and the target pressure or opening pressure of the pressure relief valve is then dynamically adjustable.

The opening pressure can thus be set to the target pressure, which enables particularly simple closed-loop control.

The device for generating the counter pressure generates counter pressure upon the compensating piston according to a further embodiment such that enough excess filling material volume can be discharged so that the target pressure arises.

The first pressure sensor is preferably in communication with a conveying chamber of a pump.

The pump is preferably a pump from the following group: rotary vane pump, auger pump, etc. These pumps are particularly suitable for filling machines. In principle, however, the present disclosure is also suitable for gear pumps, piston pumps, claw pumps, etc.

If the pump is a rotary vane pump or an auger pump, it is advantageous to have the pressure sensor have a smaller diameter than the width of the conveying elements, e.g. the vanes of the rotary vane pump or of the auger flight. The width of the vanes of the rotary vane pump is understood to mean the dimension of the outer side of a vane that abuts against the inner contour of the pump. The width of the auger flight is likewise understood to mean the width of an auger flight on the side where the flight abuts against the housing. It is also possible for the sensor to be in communication with the conveying chamber by way of an opening, e.g. a gap, in which case the opening or the gap has a width that is smaller than the width of the conveying element. It can thus be ensured that the pressure is measured in one chamber and not in chambers extending one behind the other.

The disclosure also relates to a method for filling the filling material using a filling machine, where the filling material is introduced into an inlet region of the pump, compressed in a compression region, and ejected into an outlet region, where the pressure in the compression region is adapted during the filling process by: measuring the pressure in the compression region using a first sensor and continuously adjusting the pressure in the compression region using an adjustment device. As discussed at the outset, the possibility of a selective adjustment and the adaptation of the pressure in the compression region to different process conditions then arises. The pressure in the compression region can be adapted in particular continuously.

In particular, the pressure in the compression region is controlled in a closed-loop manner. Control in a closed-loop manner by way of a control device, i.e. machine control, was not possible in prior art.

Advantageously, according to the method of the disclosure, a pressure in the outlet region of the pump is measured by a second pressure sensor and the pressure in the compression region is controlled in a closed-loop manner, where the pressure in the compression region is the controlled variable and the pressure in the outlet region is the reference variable.

According to a preferred embodiment, the actual value is the pressure measured by the first sensor and the target value is the pressure measured in the outlet region by the second pressure sensor and the adjustment device is a corresponding actuator and controls the pressure in the compression region in a closed-loop manner such that it preferably corresponds to the pressure in the outlet region.

The pressure in the compression region and the pressure in the outlet region are preferably equal at the moment the chamber is opened. However, it can also occur that only an approximation with a deviation of, for example, up to +/−10% is possible, e.g. due to leakage. Control in a closed-loop manner can also take place with a respective deviation, i.e. the target value is then higher by an amount than the pressure measured by the second pressure sensor—e.g. by 0.1%-20%. This amount can be set, for example, in the control device.

The approximation can therefore be subject to a deviation, i.e. the thinner the product is fluidically, the higher the target pressure should be chosen, since leakage is still likely.

According to a preferred embodiment, a first filling material in the method according to the disclosure, in particular food having a first compressibility, can be filled in the filling machine at a first pressure in the outlet region and a first pressure in the compression region that is adapted accordingly by the adjustment device, after which a second filling material, in particular food having a second compressibility, is filled, where the pressure in the compression region is adapted by the adjustment device to the second pressure measured in the outlet region. This makes it possible to ensure a suitable pressure ratio during the filling process. The first and the second filling material can be the same filling material, but with a fluctuating or different composition, such as a different air content or different chunkiness. The first and the second filling material can also be different filling materials, such as, firstly, white sausage meat and, secondly, salami mass. The present disclosure shall be explained hereafter in more detail with reference to the following figures.

### BRIEF DESCRIPTION OF THE FIGURES

FIG. 1 schematically shows a side view of a filling machine according to an embodiment of the present disclosure.

FIG. 2 schematically shows a cross section through a rotary vane cell pump according to the present disclosure.

FIG. 3 schematically shows a longitudinal section through the pump shown in FIG. 2.

FIG. 4 shows a further longitudinal section through a further embodiment with an auger pump according to the present disclosure.

FIG. 5 shows a closed-loop control circuit according to an embodiment of the present disclosure.

FIG. 6 shows a schematic illustration of a further embodiment with a compensating cylinder as an adjustment device.

### DETAILED DESCRIPTION

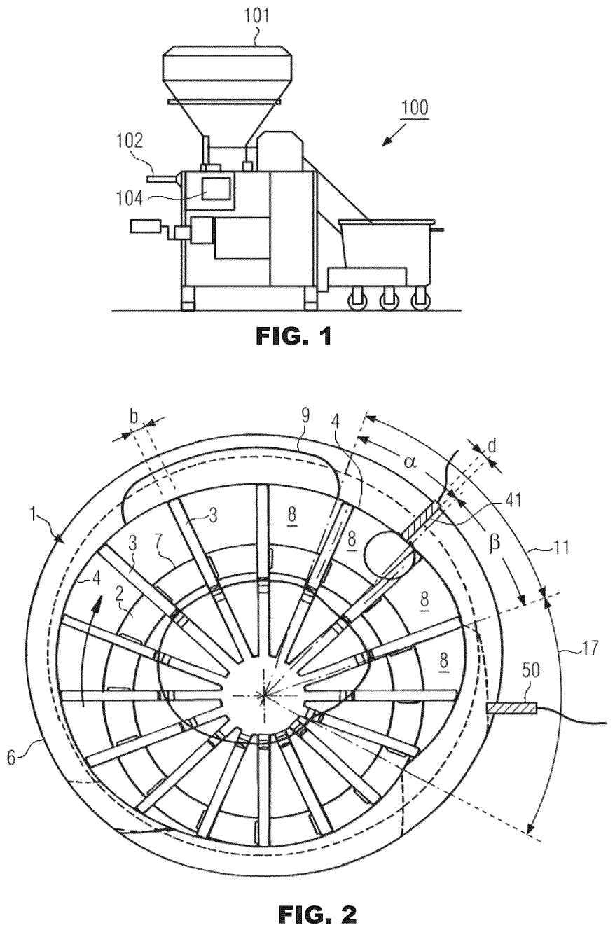

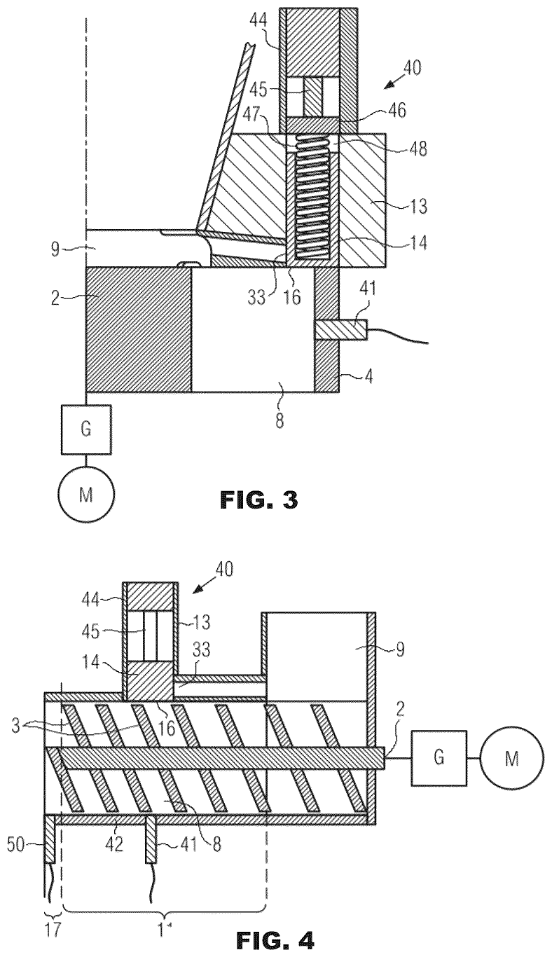

FIG. 1 schematically shows a filling machine 100 according to an embodiment of the present disclosure. Such a filling machine 100 comprises, for example, a funnel 101 into which filling material, in particular food such as sausage meat, pasty substances, etc., can be filled. This funnel is in communication with a pump 1, presently, for example, rotary vane pump 1 shown in FIGS. 2 and 3 or the auger pump shown in FIG. 4, and conveys the filling material, e.g., into a stuffing tube 102 or a linking nozzle in order to produce, for example, sausages, as is generally known. FIG. 1 further shows a sausage meat trolley and a lifting device via which the filling material can be filled into funnel 101. The present disclosure further comprises a control device 104, i.e. a machine control device.

FIG. 2 shows a cross section through a possible embodiment of a pump 1, presently a rotary vane pump. As is evident in particular from FIG. 2, rotary vane pump 1 comprises a pump housing 6 and a rotor 2 that is disposed eccentrically therein and can be made to rotate, and vanes 3 that are mounted to be radially displaceable in the latter, and with pump wall 4 of pump housing 1, the base and the cover of the pump housing, and outer surface 7 of rotor 2 form conveying cells 8 and interact in a sealing manner, where pump housing 6 comprises an inlet region 9 and an outlet region 17. Disposed between inlet region 9 and outlet region 17 is a compression region 11. In inlet region 9, conveying chambers 8 are being completely filled with the filling material. The volume of conveying chamber 8 is reduced in compression region 11 of the pump. This increases the internal pressure in conveying chamber 8. This increase depends upon the compressibility of the filling material. In addition to a first sector in the direction of rotation of the pump in an angular range a in which the volume of the conveying chambers decreases, compression region 11 can comprise a downstream sector in a subsequent angular range β in which the volume of conveying chamber 8 remains substantially the same and the pressure therefore also remains substantially the same, as is evident in particular from FIG. 2.

In compression region 11, for example, an adjustment device 40 is provided in the cover of pump housing 6, as is evident from FIG. 3. Adjustment device 40 is presently configured in the form of a pressure relief valve with a compensating cylinder 13 and a compensating piston 14, with a spring 47. A device for generating counter pressure 45, 44, 46 preloads spring 47, meaning that installation space 48 of spring 47 is shorter than the non-preloaded spring so that a defined opening pressure is set (for example 1.5 to 20 bar). Actuator 45, 46 can be used to adjust the length of installation space 48 and thereby also the preload force which depends on the spring characteristic of the spring used. If the pressure in the compression region increases, the force upon contact surface 16 of compensating cylinder 14 also increases. If the preload force is exceeded by the force acting due to the internal pressure of conveying chamber 8, i.e. if the pressure in conveying chamber 8 increases to a pressure that is greater than the opening pressure, then compensating piston 14 rises and an excess volume of filling material can be discharged, in particular via discharge line 33 and be fed again e.g. to inlet region 9, as illustrated in FIG. 3. The pressure in conveying chamber 8 can thus be adjusted to the opening pressure of pressure relief valve 40. The adjustment of the preload force can therefore be effected by the device for generating counterforce which is composed of plate 46 of spindle 45 and drive 44

According to the present disclosure, adjustment device 40, in this case, for example, motor 44, is connected to control device 104. According to the disclosure, the opening pressure of compensating piston 14 becomes dynamically variable. It can therefore be influenced in a selective manner. The adjustment device can also be controlled pneumatically or hydraulically.

The adjustment device therefore presently acts as a pressure limiter.

According to the present disclosure, pump 1 comprises a first pressure sensor 41 which is arranged in pump wall 4 and can measure the pressure in compression region 11. Pressure sensor 41 can therefore either be integrated flush in pump wall 4 of pump housing 6 or in particular flush in the base of pump housing 6 or in the cover, or it can be in communication with a conveying chamber 8 in the compression region via an opening. Pressure sensor 41 can also be integrated in the adjustment device, i.e. presently in a device for generating counter pressure upon a spring 47 or a compensating piston 14, in particular in the corresponding drive (e.g. linear drive or spindle drive-not shown). This saves a component. It is merely essential that the pressure in compression region 11 be determined. First pressure sensor 41 is connected to control direction 104. Depending on the objective, the pressure in the compression region can be kept at a certain level or can also be changed. If the pressure in conveying chamber 8 is to be changed, this can be done, for example, such that the opening pressure of pressure relief valve 40 is changed by changing the preload of spring 47 accordingly by way of device 44, 45, 46. The opening pressure is then set to the target pressure in conveying chamber 8. The pressure in the compression region, i.e. in corresponding conveying chamber 8, can thus be limited in a simple manner, in particular controlled in a closed-loop manner. For this purpose, an active drive, in particular the aforementioned linear drive, can be provided to adjust the preload of the spring. The aim can be to set a specific pressure to achieve the maximum pressure for a specific filling material, or to set different pressures depending on the air content and the type of product, or to set the pressure in the compression region to the pressure in outlet region 17. For this purpose, a second pressure sensor 50 can be provided which measures the pressure in outlet region 17. This sensor 50 is likewise connected to control device 104. Sensor 50 is preferably arranged in the discharge nozzle, in the side wall, or in the base of the outlet region.

As shall be explained in more detail hereafter, the pressure in the compression region can thus be controlled in a closed-loop manner as a function of the pressure measured in outlet region 17.

The pressure relief valve shown in FIG. 3 is only one example of an adjustment device 40. Alternatively, spring 47 can be omitted and the motion of compensating piston 14 is pressure-controlled or travel-controlled.

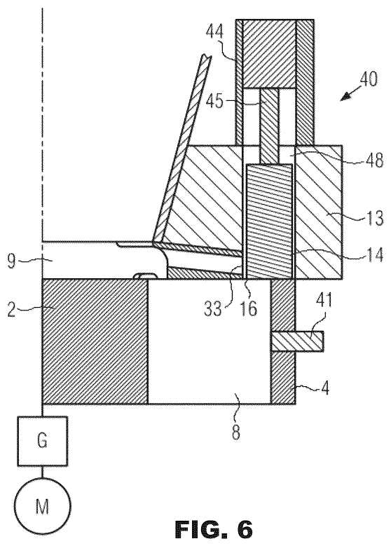

A further embodiment of an adjustment device is shown in FIG. 6, where this embodiment corresponds substantially to the embodiment shown in FIG. 3 with the exception that the adjustment device there does not comprise a pressure relief valve with a spring. The adjustment device comprises a compensating cylinder 13, where the excess volume from the compression region can be passed into the compensating cylinder in order to set or control a certain pressure in a closed-loop manner. In compensating cylinder 13, for example, a pressure-controlled or travel-controlled compensating piston 14 is arranged, upon which, for example, a device for generating counter pressure exerts a force in order to position the compensating piston in the compensating cylinder such that an excess amount of filling material can be discharged, e.g. via discharge line 33. A corresponding drive, e.g. a linear drive, i.e. motor 44, is provided for this purpose.

As an alternative to adjusting the preload distance in installation space 48, a space that is adjustable under pressure can be configured which makes the counter pressure upon the compensating piston controllable.

The present disclosure has been described in the context of a rotary vane pump. The inventive concept also works just as well for auger pumps and twin-auger pumps, as illustrated, for example, in FIG. 4.

The auger pump likewise comprises an inlet region 9, a compression region 11 in which the filling material is compressed by the auger flight, i.e. conveying elements 3, and an outlet region 17 where the filling material is ejected. Here as well, a first pressure sensor 41 is disposed in compression region 11 and a second sensor 50 in outlet region 17. Adjustment device 40 is disposed in the compression region, just like in the previous embodiment. The function, the sensors, and the adjustment device correspond to the elements explained in detail in the previous embodiment. Here as well, the pressure in the compression region can therefore be adjusted, in particular controlled in a closed-loop manner, in particular as a function of the pressure measured in outlet region.

Like in the previous embodiment, pressure sensor 41 advantageously has a smaller diameter a than width b of conveying elements 3, in particular of vanes 3 of the rotary vane pump or the auger flight. Alternatively, as already described above, the pressure sensor in communication with conveying chamber 8 in compression region 11 via an opening, e.g. a gap that is narrower than the width of conveying element 3.

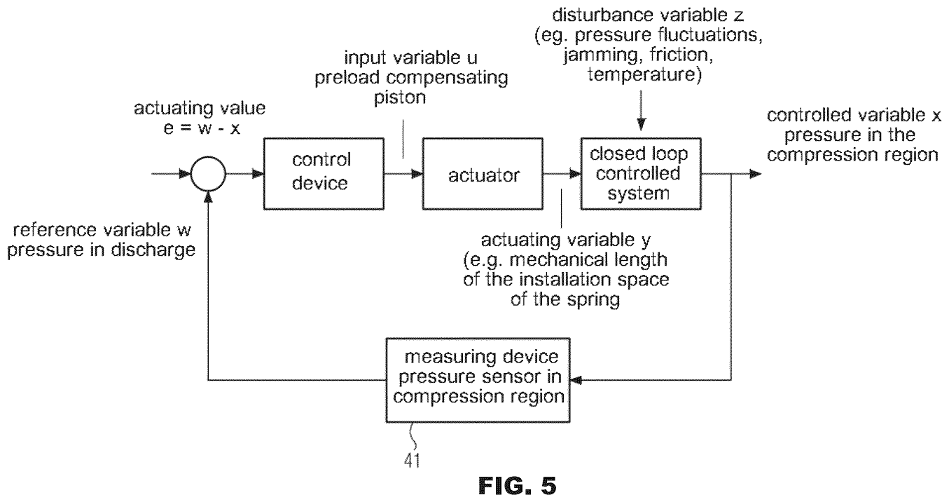

The method according to the disclosure as well as the control device according to the disclosure shall be explained in more detail hereafter with reference to FIGS. 1 to 5. FIG. 5 shows a closed loop of a possible embodiment of the present disclosure.

First, as shown in FIG. 1, filling material is filled into a filling funnel 101 and passed into inlet region 9 of pump 1. For this purpose, the pump runs at a rotational speed or delivers a volume per unit of time such that conveying chambers 8 fill completely. The filling material enters conveying chamber 8 between two conveying elements 3 (see FIGS. 2 and 4), where the filling material is compressed in the compression region and ejected in outlet region 17. First pressure sensor 41 measures the pressure in compression region 11 and presently therefore represents the measuring device mentioned in FIG. 5.

Controlled variable x is the pressure in the compression region. Sensor 50 measures the pressure in discharge region 17. The pressure in discharge region 17 represents reference variable w. The pressure measured by pressure sensor 50 is also passed to the control device. And e=w−x is determined as an actuating value. The adjustment device, i.e. the actuator, is controlled, for example, motor 44 of adjustment device 40, as a function of the actuating value in order to set a corresponding input variable, for example, the preload of compensating piston 14 or the opening pressure, respectively. The actuating variable there is, for example, the mechanical length of installation space 48 for the spring or the resulting spring load, respectively. There are various disturbance variables z in the closed loop controlled system, such as pressure fluctuations, jamming, friction, temperature, etc. Sensor 41 measures the resulting pressure in the compression region and passes this measured value on to the control device. If, for example, the filling material changes, i.e. the proportion of air increases and therefore also the compressibility, then the respective control adjustments must be made. This takes place continuously during the process.

If the actual pressure in the compression region exceeds the target value, i.e. the opening pressure of the pressure relief valve, then the pressure relief valve opens and excess filling material is discharged.

The pressure in the compression region can also be limited, in particular controlled in a closed-loop manner, to a certain value using the adjustment device independently of the measured pressure in the outlet region.

1. A filling machine for filling filling material, with
a pump which comprises an inlet region, a compression region, and an outlet region, comprising
a first pressure sensor for measuring a pressure in said compression region, and
an adjustment device for adjusting different pressures in said compression region.

2. The filling machine according to claim 1, wherein
said filling machine comprises a control device and said adjustment device is controllable by said control device and is configured such that it can dynamically set the pressure in said compression region to control it in a closed-loop manner.

3. The filling machine according to claim 1, wherein
said filling machine comprises a second pressure sensor for measuring a pressure in said outlet region and a control device which is configured such that it controls the pressure in said compression region in a closed-loop manner as a function of the pressure measured in said outlet region, wherein
the pressure in said compression region is a controlled variable and the pressure in said outlet region is a reference variable.

4. The filling machine according to claim 3, wherein
said control device is configured such that the pressure in said compression region is controlled as a controlled variable, and
an actual value is the pressure measured by said first pressure sensor,
a target value is the pressure measured in said outlet region by said second pressure sensor and an actuator is said adjustment device.

5. The filling machine according to claim 1, wherein
said adjustment device is configured as a pressure limiter and, if a target pressure in said compression region is exceeded, can discharge excess volume from said compression region, from a conveying chamber, via a discharge line or into a compensating cylinder.

6. The filling machine according to claim 5, wherein
the target pressure in said compression region is variable and dynamically adaptable and corresponds to an opening pressure of said adjustment device, wherein the opening pressure of said adjustment device is variable and dynamically adjustable.

7. The filling machine according to claim 5, wherein
said adjustment device is in fluid communication with said compression region is configured as a valve, or comprises the compensating cylinder with a compensating piston.

8. The filling machine according to at least claim 7, wherein
said adjustment device is configured as a pressure relief valve and comprises, for example, a spring that is preloaded by a device for generating counter pressure, wherein a spring load can be dynamically adjusted by said device for generating counter pressure and the target pressure,, is thereby dynamically adjustable and/or
said adjustment device comprises the compensating cylinder which comprises the compensating piston and a volume that can be discharged from said compression region into said compensating cylinder and thereby the target pressure is adjustable by said device for generating counter pressure upon said compensating piston.

9. The filling machine according to claim 1, wherein
said first pressure sensor in said compression region is in communication with a conveying chamber of said pump.

10. The filling machine according to claim 1, wherein said pump is a rotary vane pump or an auger pump or a twin-auger pump.

11. The filling machine according to claim 1, wherein said pump is a rotary vane pump or an auger pump, wherein said pressure sensor has a smaller diameter than a width of conveying elements including vanes of said rotary vane pump or an auger flight of said auger pump.

12. A method for filling filling material using a filling machine,
wherein the filling material is introduced into an inlet region of said pump, compressed in a compression region, and ejected into an outlet region, wherein
pressure in said compression region is adapted during a filling process by:
measuring a pressure in said compression region with a first pressure sensor, and
adjusting the pressure in said compression region using an adjustment device.

13. The method according to claim 12, wherein the pressure in said compression region is controlled in a closed-loop manner and said adjustment device is controlled by a control device and dynamically adjusts the pressure in said compression region.

14. The method according to at least claim 13, wherein the pressure in said outlet region of said pump is measured by a second pressure sensor and,
wherein the pressure in said compression region is a controlled variable and the pressure in said discharge region is a reference variable, and
an actual value is the pressure measured by said first sensor and a target value is the pressure measured in said outlet region by said second pressure sensor and said adjustment device as an actuator controls the pressure in said compression region in a closed-loop manner such that it corresponds to the pressure in said outlet region or
an actual value is the pressure measured by said first sensor and a target value is the pressure measured in said outlet region by said second pressure sensor and said adjustment device as an actuator controls the pressure in said compression region in a closed-loop manner.

15. The method according to claim 12, wherein
a first filling material having a first compressibility is filled in said filling machine at a first pressure in said outlet region and a first pressure correspondingly adapted by said adjustment device and compression region, after which
a second filling material having a second compressibility is filled, wherein the pressure in said compression region is adapted by said adjustment device to the pressure measured in said outlet region.

16. The method according to claim 12, wherein the pressure in said compression region is set to be controlled in a closed-loop manner, to be equal to or greater, in particular by 0.1-20%, than the pressure in said outlet region.

17. The filling machine according to claim 1, wherein said pressure sensor
is either integrated flush in a pump wall of a pump housing or flush in a base of said pump housing or in a cover, or it can be in communication with a conveying chamber in said compression region via an opening, or
is integrated in said adjustment device in a corresponding drive of a device for generating counter pressure upon a spring or a compensating piston.

18. The filling machine according to claim 7, wherein the valve is a pressure relief valve or control valve.

19. The filling machine according to claim 8, wherein said device for generating counter pressure comprises a drive.

20. The filling machine according to claim 19, wherein said drive is a linear or spindle drive with an integrated pressure sensor.
